(19) United States
(12) Patent Application Publication
(10) Pub. No.: US 2026/0170028 A1
(43) Pub. Date: Jun. 18, 2026

(54) DIALOGUE DEVICE AND DIALOGUE METHOD

(71) Applicant: HITACHI, LTD., Tokyo (JP)

(72) Inventors: Taichi HISATSUNE, Tokyo (JP); Takahito TANIMURA, Tokyo (JP); Yuichi KITAGAWA, Tokyo (JP); Kazuhisa UCHIYAMA, Tokyo (JP); Takahiro SUZUKI, Tokyo (JP); Tatsuya ISHIZAKA, Tokyo (JP)

(21) Appl. No.: 19/304,715

(22) Filed: Aug. 20, 2025

(30) Foreign Application Priority Data
Dec. 12, 2024 (JP) 2024-217449

(51) Int. Cl. G06F 16/3329; G06N 5/022

(52) U.S. Cl. CPC G06F 16/33295; G06N 5/022

(57) ABSTRACT

A dialogue device generates a new question based on premise knowledge of a question asked by a user to acquire an answer, wherein the dialogue device includes a dialogue unit that outputs an answer acquired by transmitting to a language model server a prompt including related obvious information to a tendency of a questioner who has asked the question. The tendency is language information associated with the question and associated with a state of the questioner. The obvious information is language information describing knowledge related to the question. For example, the prompt is a prompt for requesting an output of at least one of a question related to the question asked by the questioner, a question subsequent to the asked question, and a question to ask back of the questioner. Alternatively, the prompt is a prompt, for example, for requesting an answer to the question asked by the questioner.

### REFERENCE TO RELATED APPLICATIONS

The present invention relates to and asserts priority from Japanese patent application No. 2024-217449 filed on Dec. 12, 2024, and incorporates the entirety of the contents and subject matter of all the above application herein by reference.

### TECHNICAL FIELD

The present invention relates to a dialogue device and a dialogue method using a language model.

### BACKGROUND ART

With the progress of generative artificial intelligence (AI) technology, development of a dialogue system utilizing a language model (large language model) is in progress. The language model is a machine learning model that enables natural conversation with humans by learning a large amount of text data. The dialogue system connected to the language model can execute advanced language processing tasks such as information extraction, translation, summarization, and similar sentence generation in addition to general conversation.

On the other hand, because the language model learns data published on the Internet or the like, it is difficult to answer about specialized knowledge (expertise). Therefore, in industrial application of the generative AI, a method called RAG (Retrieval-Augmented Generation) that outputs an answer including unique information by combining a language model and a knowledge database has been spotlighted. In RAG, a text document describing the specialized knowledge is divided into a certain amount of text (chunk) and stored in a knowledge database in advance. Thereafter, in response to a question from a user, a chunk similar to the question (text of the question) is extracted and embedded in a prompt, and thus the language model generates an answer based on the chunk. By using the RAG, when the user asks a question with specialized content, the language model can generate an answer based on the specialized knowledge.

On the other hand, in the RAG, the language model refers only to the chunk included in the prompt, and cannot generate an answer based on information more than the content described in the chunk. For example, it is assumed that a procedure manual including procedures 1 to 10 is stored in the knowledge database. When only the procedure 3 is extracted as a chunk in response to the user's question, the language model can answer based on the content of the procedure 3. However, the language model cannot generate an answer based on the procedure 1 and the procedure 2 that are premises for execution of the procedure 3, information (knowledge) that is the premises, and knowledge that is a background. A reader of a specialized document often needs knowledge that serves as a premise or a background (hereinbelow, also simply referred to as premise knowledge), and it is necessary to adjust a description level according to a knowledge base of the reader.

An example of an information extraction and information expansion method in a dialogue system is described in NPL 1. When a knowledge graph is constructed by extracting a triple of a subject, a predicate, and an object from a sentence, important information such as time and place is missing in a case of a sentence including a meaning of a binary relation or more. The technique described in NPL 1 describes 5W1H information of who, when, where, what, why, and how; and a predicate for each chunk referring to a schema of a knowledge graph provided in a knowledge graph inference challenge. The technique described in the above NPL 1 uses a discourse relation to describe a semantic relationship between chunks. As a lexical system of the discourse relation, the OLiA Annotation Model for PTDB relations is used.

### CITATION LIST

### Non-Patent Literature

[NPL 1] Shusaku Egami, Kenichiro Fukuda, “RAG using knowledge graph based on chunk of document”, Proceedings of 30th annual meeting of Japanese Society for Language Processing, pgs. 2455 to 2460, [retrieved on Nov. 18, 2024], Internet <URL: https://www.anlp.jp/proceedings/annual_meeting/2024/pdf_dir/C9-2.pdf>

### SUMMARY OF INVENTION

### Technical Problem

In the technique of NPL 1, a chunk is extracted and included in a prompt in consideration of a semantic relationship between chunks and structural information. However, this technique does not consider premise knowledge needed to understand the chunks themselves. If the document itself on which the extraction of the chunk is based does not include description of the premise knowledge, the extraction is difficult. As a result, it is difficult to provide an answer that matches the premise knowledge of the user (questioner).

The present invention has been made in view of such a background, and an object of the present invention is to provide a dialogue device and a dialogue method for generating a new question to the user's question based on premise knowledge of the user's question and acquiring an answer.

### Solution to Problem

In order to solve the above-described problem, a dialogue device according to the present invention includes a dialogue unit that outputs an answer acquired by transmitting to a language model server a prompt including obvious information related to a tendency of a questioner who has asked a question. Here, the tendency is language information associated with the question and a state of the questioner, and the obvious information is language information indicating knowledge related to the question.

### Effects of Invention

According to the present invention, it is possible to provide a dialogue device and a dialogue method for generating a new question based on premise knowledge of a question from a user and acquiring an answer to the question. Problems, configurations, and effects other than those described above is clarified by below descriptions of embodiments.

### BRIEF DESCRIPTION OF DRAWINGS

FIG. 1 is a functional block diagram of a dialogue device according to an embodiment of the present invention.

FIG. 2 is a data configuration diagram of a technical term database according to the embodiment.

FIG. 3 is a flowchart of a construction processing of a premise knowledge database according to the embodiment.

FIG. 4 is a diagram showing a technical term explanation prompt according to the embodiment.

FIG. 5 is a diagram showing an answer from a language model server to the technical term explanation prompt according to the embodiment.

FIG. 6 is a diagram showing a premise knowledge generation prompt according to the embodiment.

FIG. 7 is a diagram showing an answer from the language model server to the premise knowledge generation prompt according to the embodiment.

FIG. 8 is a graph showing a configuration of a premise knowledge graph according to the embodiment.

FIG. 9 is a diagram for explaining addition of a premise knowledge graph to the premise knowledge database according to the embodiment.

FIG. 10 is a flowchart of an obvious information acquisition process according to the embodiment.

FIG. 11 is a diagram showing a tendency generation prompt according to the embodiment.

FIG. 12 is a diagram showing an answer from the language model server to the tendency generation prompt according to the embodiment.

FIG. 13 is a flowchart of a dialogue process according to the embodiment.

FIG. 14 is a diagram showing a dialogue screen according to the embodiment.

FIG. 15 is a diagram showing a related question generation prompt according to the embodiment.

FIG. 16 is a diagram showing an answer from the language model server to the related question generation prompt according to the embodiment.

FIG. 17 is an example showing a part of a specification according to a modification of the embodiment.

FIG. 18 is an example showing a tendency of readers of the specification according to the modification of the embodiment.

FIG. 19 is an example showing obvious information of the specification according to the modification of the embodiment.

FIG. 20 is a flowchart of a dialogue process according to the modification of the embodiment.

FIG. 21 is a diagram showing a question and answer generation prompt according to the modification of the embodiment.

FIG. 22 is a diagram showing an answer from the language model server to the question and answer generation prompt according to the modification of the embodiment.

FIG. 23 is a diagram showing a dialogue screen according to the modification of the embodiment.

FIG. 24 is a hardware configuration diagram illustrating an example of a computer that implement functions of the dialogue device according to the embodiment described above.

### DESCRIPTION OF EMBODIMENTS

Hereinbelow, a dialogue device according to an embodiment of the present invention is described. The dialogue device acquires a tendency of a user (questioner) based on a question from the user, acquires obvious information related to the tendency, and generates a prompt for obtaining a question associated to the question. Note that it is assumed that the user of the dialogue device belongs to a specific organization/group, and the content of the question relates to the business or the specialized field of the organization/group.

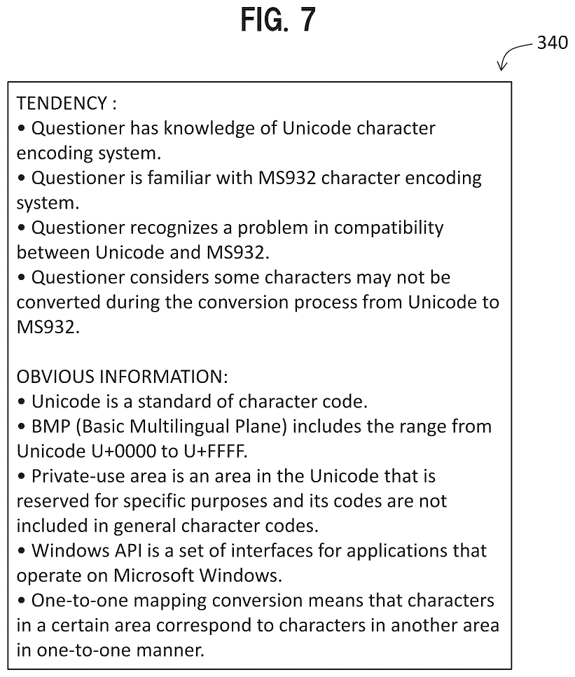

The tendency is information (language information) indicated by text (language, characters) depending on a state of the user who has asked the question and is information that the user understands or recognizes regarding the question. Examples of the tendency include technical terms/specialized knowledge understood by the user, problems/questions recognized by the user, and technical terms/specialized knowledge required by the user (see FIG. 7 described below).

The obvious information is information (language information) that does not depend on the user who has asked the question, and is information (knowledge) related to the question, which information is understood/recognized even by other members in the same manner as long as the members are in a specific group such as an organization/association or a team. The obvious information may be information (knowledge) related to the specialized field/technical field related to the question.

The tendency and the obvious information are generated based on the past dialogue (questions and answers). The tendency and the obvious information may be generated based on in-house materials such as specifications and user guides of equipment and a system, a business procedure manual, a written proposal, and a notice. The tendency and the obvious information are also referred to as premise knowledge.

The dialogue device acquires and outputs an answer to a question from a user using a language model (see a language model server 200 described below). The dialogue device also generates a prompt for acquiring a question associated with the user's question such as a question related to the user's question, a question following the user's question, and a question that the dialogue device asks back to the user and inquires the prompt of the language model to acquire and output an answer. According to such a dialogue apparatus, the user can immediately ask a question for obtaining related information, information that the user wants further to know, and the like. This allows the user to efficiently obtain the technical information.

The question associated with the user's question may be the user's question itself, and the dialogue device may include the obvious information related to the user's tendency into the prompt to obtain and output an answer to the user's question itself. According to such a dialogue device, the user can efficiently resolve questions and unclear points.

### Configuration of Dialogue Device

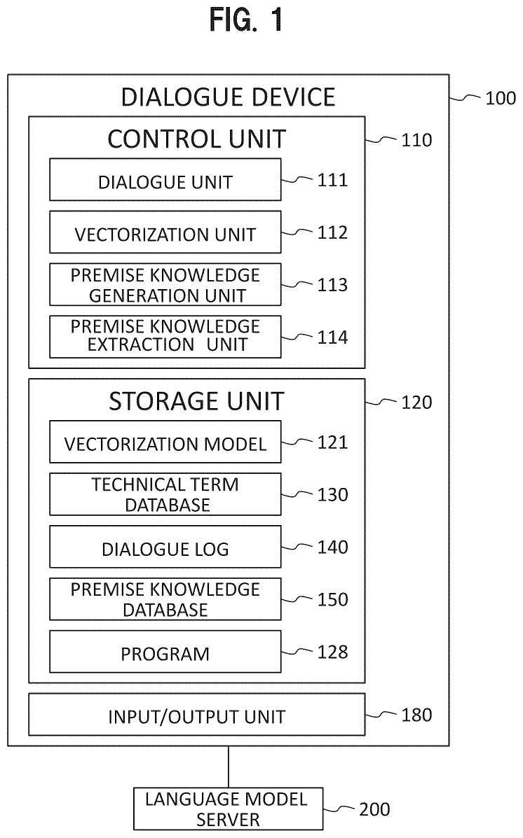

FIG. 1 is a functional block diagram of a dialogue device 100 according to the embodiment. The dialogue device 100 is a computer and includes a control unit 110, a storage unit 120, and an input/output unit 180. The input/output unit 180 is connected to user interface devices such as a display, a keyboard, and a mouse. The input/output unit 180 also includes a communication device and can transmit and receive data to and from the language model server 200.

The dialogue device 100 sends a prompt, which is a question/instruction written in text, to the language model server 200. The language model server 200 generates an answer to the prompt using a language model (large language model) and returns the answer to the dialogue device 100.

### Dialogue Device: Storage Unit

The storage unit 120 includes a storage device such as a read only memory (ROM), a random access memory (RAM), or a solid state drive (SSD). The storage unit 120 stores a vectorization model 121, a technical term database 130, a dialogue log 140, a premise knowledge database 150, and a program 128. The program 128 includes a description of processing executed by a functional unit included in the control unit 110 described below. Note that the various storage contents in the storage unit 120 may be read therein as necessary from among those stored in an external storage device such as a cloud server.

### Storage Unit: Vectorization Model

The vectorization model 121 is a machine learning model that is used when converting a text (language information) into a vector (numerical value). The input (explanatory variable) of the vectorization model 121 is a text, and the output (objective variable) is a vector. Texts with similar content are converted into similar vectors. The similarity of the vectors is calculated as cosine similarity.

### Storage Unit: Technical Term Database

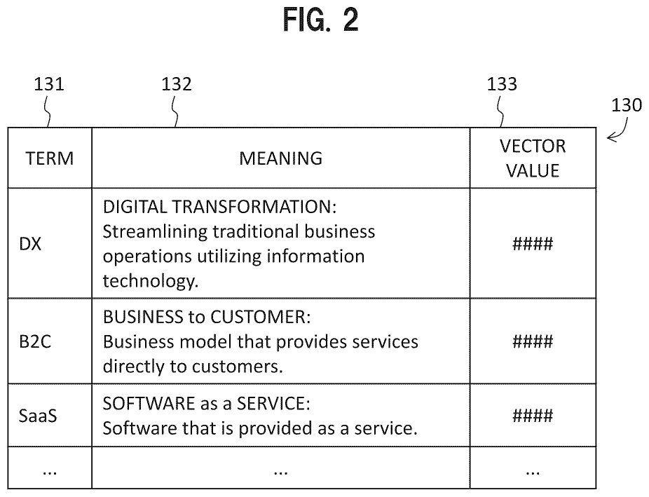

FIG. 2 is a data configuration diagram of the technical term database 130 according to the embodiment. The technical term database 130 stores therein terms 131 of the specialized field, meanings 132 of the terms, and vector values 133 of the meanings in association with one another. The vector value 133 is a text indicating the meaning 132 converted using the vectorization model 121. The technical term database 130 is not limited to one, and may be provided for each department, role, project, a target to be queried such as facility, system, and specialized field, or the like.

### Storage Unit: Dialogue Log

Referring back to FIG. 1, the storage unit 120 is further described. The dialogue log 140 records a dialogue (question and answer) between the dialogue device 100 and the user. The dialogue log 140 may store a dialogue of a dialogue device, a dialogue system, or an AI chat system that are different from the dialogue device 100, but is assumed to be a field (business content or specialized field) assumed by the dialogue device 100. The dialogue log 140 includes identification information of a user who is making a dialogue, and information such as the department, role, project, and specialized field of the user can be acquired.

### Storage Unit: Premise Knowledge Database

The premise knowledge database 150 (see FIG. 9 described below) stores the tendency of the user and the obvious information in association with each other. The premise knowledge database 150 is not limited to one, and may be provided for department, role, or project of the user, each facility, system, and specialized field to be questioned, or the like. A method of constructing the tendency, obvious information, and premise knowledge database 150 is described below.

### Dialogue Device: Control Unit

The control unit 110 includes a central processing unit (CPU), and includes a dialogue unit 111, a vectorization unit 112, a premise knowledge generation unit 113, and a premise knowledge extraction unit 114. The control unit 110 may include a graphics processing unit (GPU), a neural (network) processing unit (NPU), a field programmable gate array (FPGA), an application specific integrated circuit (ASIC), or the like.

### Control Unit: Dialogue Unit

The dialogue unit 111 receives a question from a user. The dialogue unit 111 also outputs an answer to the question, which answer is, acquired from the language model server 200, on a display connected to the input/output unit 180.

### Control Unit: Vectorization Unit

The vectorization unit 112 converts a text (language information) into a vector using the vectorization model 121.

### Control Unit: Premise Knowledge Generation Unit/Premise Knowledge Database Construction

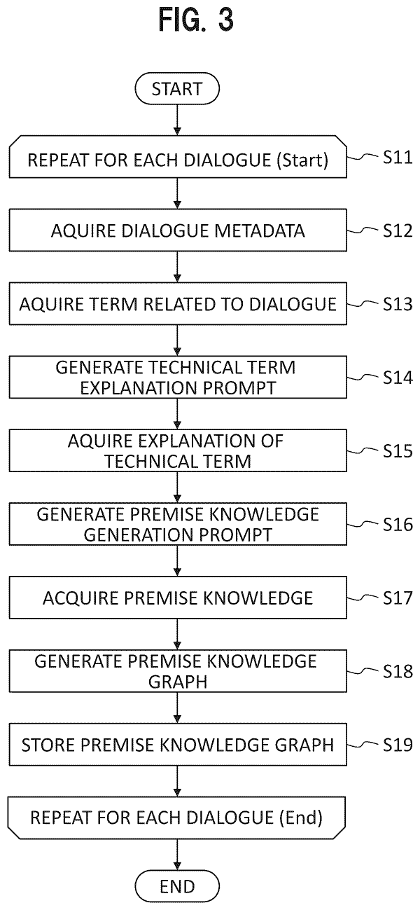

The premise knowledge generation unit 113 generates premise knowledge based on the dialogue stored in a dialogue log 140, and stores the premise knowledge in the premise knowledge database 150. Hereinbelow, a method of constructing the premise knowledge database 150 by the premise knowledge generation unit 113 is described with reference to FIG. 3.

FIG. 3 is a flowchart of a construction processing of the premise knowledge database according to the embodiment. At a time of starting the premise knowledge database construction processing, the dialogue log 140 already stores a dialogue.

In step S11, the premise knowledge generation unit 113 starts a process of repeating steps S12 to S19 for each dialogue stored in the dialogue log 140. Hereinbelow, each dialogue processed in the repeated processing is also referred to as a processing target dialogue.

In step S12, the premise knowledge generation unit 113 acquires metadata of the processing target dialogue. The metadata is information related to the user who is performing the processing target dialogue (who has issued the question), and is, for example, identification information, a department, a role, and a project of the user. The metadata may be a facility, a system, or a specialized field that is designated by the user and is a target of the question.

In step S13, the premise knowledge generation unit 113 acquires terms related to the processing target dialogue from the technical term database 130 (see FIG. 2) associated with the metadata acquired in step S12. More specifically, the premise knowledge generation unit 113 instructs the vectorization unit 112 to convert the question included in the processing target dialogue into a vector. Next, the premise knowledge generation unit 113 acquires the terms 131 and the meanings 132 whose vector value 133 is equal to or greater than a predetermined value in its cosine similarity with the vector.

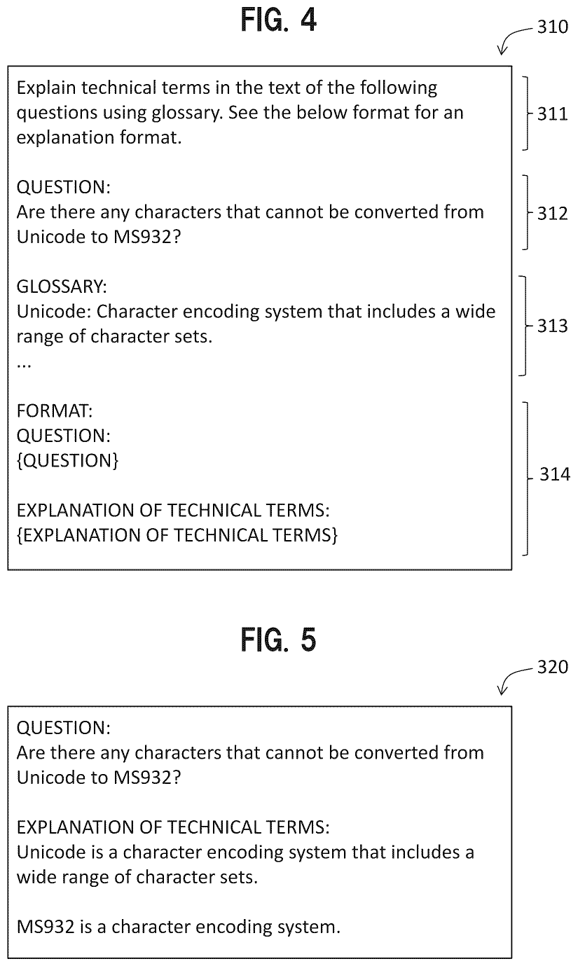

In step S14, the premise knowledge generation unit 113 generates a technical term explanation prompt 310 (see FIG. 4 described below). FIG. 4 is a diagram illustrating a technical term explanation prompt 310 according to the embodiment. Element 311 of the technical term explanation prompt 310 includes a sentence instructing to explain the technical terms included in the question in element 312 using a glossary in element 313 and in accordance with a format in element 314.

The element 312 includes a question included in the processing target dialogue. The element 313 includes the terms 131 and the meanings 132 acquired in the step S13. The element 314 indicates the format of the explanation, which includes a header line of the question, a line of content of the question (see the element 312)”, a blank line, a header line of the technical term explanation, and a line of content of the technical term explanation.

Referring back to FIG. 3, further description continues about the premise knowledge database construction process.

In step S15, the premise knowledge generation unit 113 transmits the technical term explanation prompt 310 generated in step S14 to the language model server 200 and acquires an answer, thereby acquiring an explanation of the technical term. FIG. 5 is a diagram illustrating an answer 320 from the language model server 200 to the technical term explanation prompt 310 according to the embodiment. The answer 320 includes a question and an explanation of the terminology according to the format indicated in the element 314 (see FIG. 4).

Referring back to FIG. 3, further description continues about the premise knowledge database construction process.

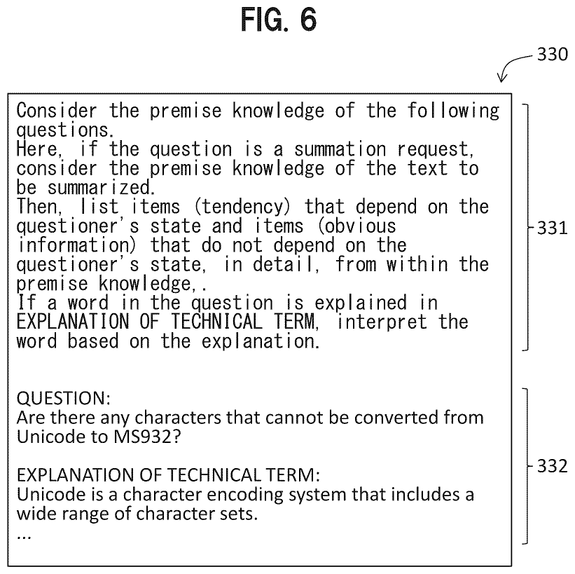

In step S16, the premise knowledge generation unit 113 generates a premise knowledge generation prompt 330 (see FIG. 6 described below). FIG. 6 is a diagram illustrating a premise knowledge generation prompt 330 according to the embodiment. The element 331 of the premise knowledge generation prompt 330 includes a sentence instructing to output, as the premise knowledge of the question in the element 332, a tendency that is an item depending on the state of the questioner and obvious information that is an item not depending on the state of the questioner. The elements 332 has the answers 320 (see FIG. 5) acquired in the step S15 embedded therein.

Referring back to FIG. 3, further description is given of the premise knowledge database construction process.

In step S17, the premise knowledge generation unit 113 transmits the premise knowledge generation prompt 330 generated in step S16 to the language model server 200 and acquires an answer, thereby acquiring the premise knowledge (tendency and obvious information). FIG. 7 is a diagram illustrating an answer 340 from the language model server 200 to the premise knowledge generation prompt 330 according to the embodiment. In FIG. 7, the answer 340 includes four items as the tendency and five items as the obvious information.

As indicated by the answer 340, the tendency is information (language information) depending on the state of the user, and is also considered to be information that is related to the question and understood or recognized by the user. The obvious information is information that does not depend on the user, and is considered to be information (knowledge) that is understood/recognized even by other members in the same extent as the user as long as they belong to a specific group such as an organization or a team to which the user belongs too. The obvious information may be information (knowledge) that is commonly known in the specialized field related to the question.

As described above, the tendency is “language information related to the state of the questioner” who is related to the question.

The obvious information is “language information that describes knowledge” related to the question.

Referring back to FIG. 3, the premise knowledge database construction process is further described.

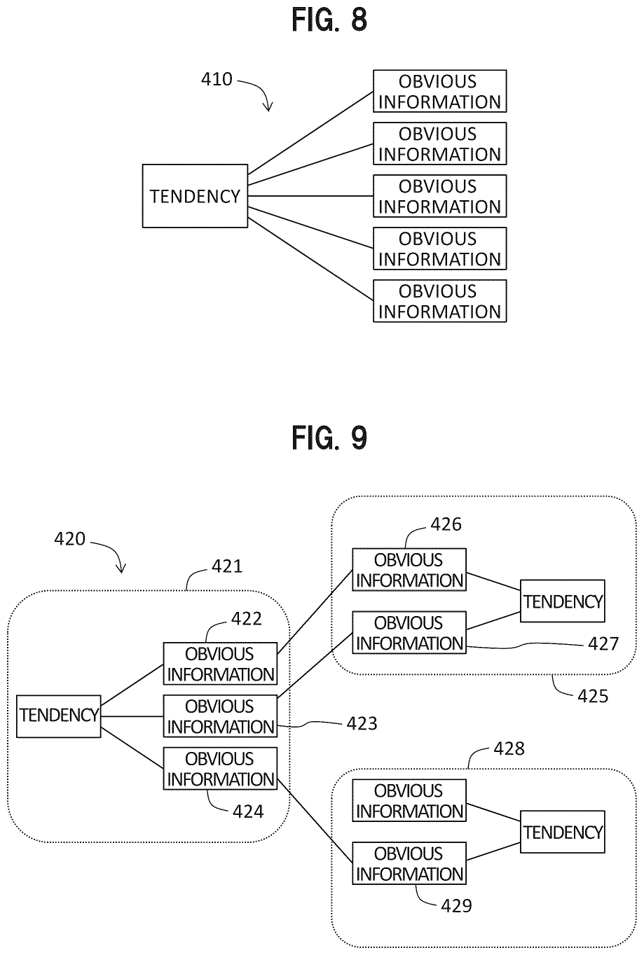

In step S18, the premise knowledge generating unit 113 generates a premise knowledge graph 410 (see FIG. 8 described below) based on the answer 340 acquired in step S17. FIG. 8 is a premise knowledge graph 410 showing a configuration of a premise knowledge graph according to the embodiment. The premise knowledge graph 410 is a graph that includes the tendency and the obvious information as nodes and a link connecting the node of the tendency and the node of the obvious information.

The tendency is a tendency included in the answer 340 to the premise knowledge generation prompt 330. The answer 340 includes four items of tendency, and these four items are collected as one tendency node. Regarding the obvious information, each item of the obvious information included in the answer 340 is a node of the obvious information. The node of the tendency is connected to each node of the obvious information by a link.

Referring back to FIG. 3, further description continues about the premise knowledge database construction process.

In step S19, the premise knowledge generation unit 113 adds the premise knowledge graph 410 generated in step S18 to the premise knowledge database 150 corresponding to the metadata acquired in step S12. When adding the graph 410, the premise knowledge generation unit 113 connects nodes of similar obvious information with links. The similar obvious information means that the cosine similarity of the vector obtained by converting the obvious information through the vectorization unit 112 is equal to or greater than a predetermined value.

FIG. 9 is a diagram for explaining addition of the premise knowledge graph 421 to the premise knowledge database 150 according to the embodiment. It is assumed that the premise knowledge graphs 425 and 428 on the right side has already been stored in the premise knowledge database 150. It is assumed that the above-described premise knowledge database 150 is added to a premise knowledge graph 421 on the left side. Here, it is assumed that the obvious information indicated by the node 422, 426 of the obvious information is similar. Further, it is assumed that the obvious information indicated by the node 423 and 427 of the obvious information is similar. Further, it is assumed that the obvious information indicated by the node 424 and 429 of the obvious information is similar. Under the above condition, the premise knowledge generation unit 113 adds the premise knowledge graph 421 by linking the nodes 422 to the nodes 426, the nodes 423 to the nodes 427, and the nodes 424 to the nodes 429 of the obvious information.

As described above, the dialogue device 100 includes the premise knowledge generation unit 113, which generates the premise knowledge generation prompt 330 (see FIG. 6) for instructing extraction of a tendency and obvious information related to the tendency from the dialogue log 140 that includes a question asked by a second questioner (questioner of a dialogue included in the dialogue log 140) including one or both of a questioner and a different questioner from the questioner and an answer from the language model server 200 to the question and transmits the premise knowledge generation prompt 330 to the language model server 200 and thereby acquires a tendency and obvious information related to the tendency to generate (construct) the premise knowledge database 150 including the tendency and the obvious information.

The premise knowledge generation unit 113 includes the explanatory text of the technical term included in the question from the second questioner (see the element 332 illustrated in FIG. 6) in the premise knowledge generation prompt 330.

The premise knowledge generation unit 113 generates one or more premise knowledge databases 150 according to the affiliation or role of the second questioner.

### Control Unit: Premise Knowledge Extraction Unit and Obvious Information Acquisition Process

Returning to FIG. 1, the description of the control unit 110 is continued. The premise knowledge extraction unit 114 acquires obvious information related (related obvious information) to the question from the user. More specifically, the premise knowledge extraction unit 114 acquires the obvious information related to the tendency of the user as the related obvious information to the question on the basis of the question from the user. The premise knowledge extraction unit 114 may include the similar obvious information acquired into the obvious information into the obvious information related to the question.

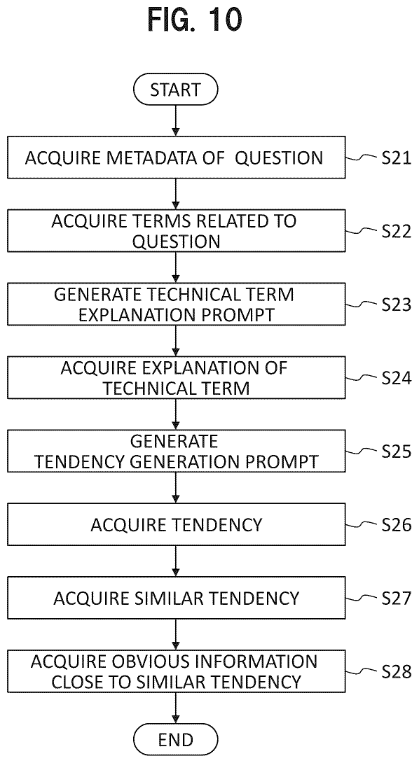

FIG. 10 is a flowchart of the obvious information acquisition process according to the embodiment. The obvious information acquisition process executed by the premise knowledge extraction unit 114 is described below with reference to FIG. 10.

Steps S21 to S24 are similar to steps S12 to S15 described in FIG. 3.

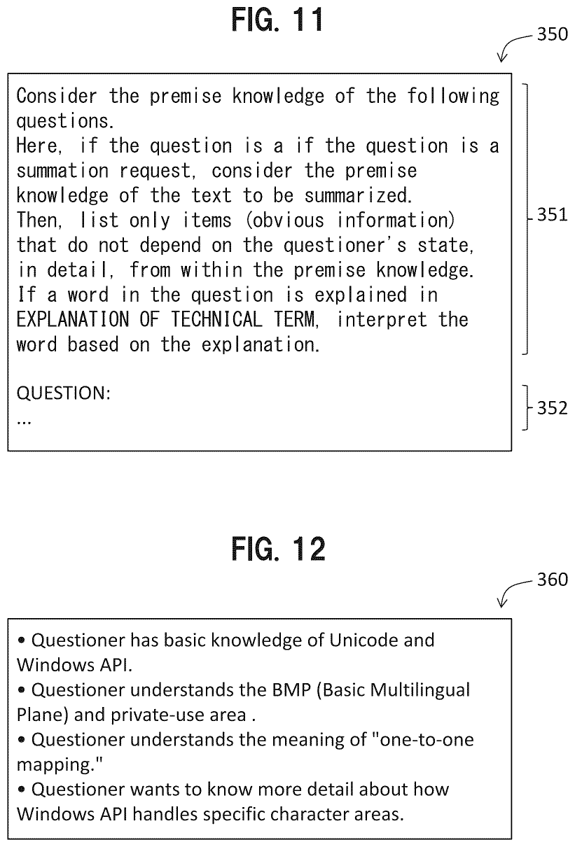

In step S25, the premise knowledge extraction unit 114 generates a tendency generation prompt 350 (see FIG. 11 described below). FIG. 11 is a diagram illustrating a tendency generation prompt 350 according to the embodiment. An element 351 of the tendency generation prompt 350 includes a sentence instructing to output the tendency of the questioner as the premise knowledge of the question in the element 352. The elements 352 has the answers (question and explanation of the technical term) acquired in step S24 embedded therein.

Referring back to FIG. 10, the obvious information acquisition process is further described.

In step S26, the premise knowledge extraction unit 114 transmits the tendency generation prompt 350 generated in step S25 to the language model server 200 to acquire an answer, and thereby acquires the tendency of the users (questioners). FIG. 12 is a diagram illustrating an answer 360 from the language model server 200 to the tendency generation prompt 350 according to the embodiment. The answer 360 includes four items as the tendency of the user.

Referring back to FIG. 10, the obvious information acquisition process is further described.

In step S27, the premise knowledge extraction unit 114 acquires a similar tendency that is similar to the tendency acquired in step S26 from the premise knowledge database 150 (see FIG. 9) corresponding to the metadata acquired in step S21. The similarity in the tendency means that the cosine similarity of the vector obtained by converting the tendency by the vectorization unit 112 is equal to or greater than a predetermined value. The predetermined value is a value that is set as appropriate in accordance with a purpose or the like.

In step S28, the premise knowledge extraction unit 114 acquires the obvious information related to the acquired tendency as the obvious information related to the question. The premise knowledge extraction unit 114 may acquire similar obvious information to the obvious information as the obvious information related to the question. For example, it is assumed that the similar tendency to the question is a tendency included in the premise knowledge graph 425. Then, the obvious information indicated by the node 422, 423, 426, and 427 is acquired as the obvious information related to the question.

As described above, the dialogue device 100 includes the premise knowledge extraction unit 114 that acquires the similar tendency to the tendency of the questioner among tendencies included in the premise knowledge database 150 (see FIG. 9) and acquires obvious information related to the tendency acquired.

The premise knowledge extraction unit 114 acquires, in addition to obvious information related to the tendency, similar obvious information to the obvious information.

The premise knowledge extraction unit 114 selects the premise knowledge database 150 according to the affiliation or role of the questioner and acquires obvious information.

### Dialogue Processing

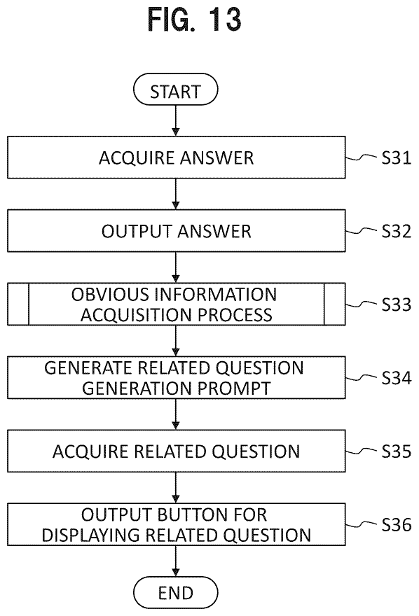

FIG. 13 is a flowchart of the dialogue process according to the embodiment. Referring to FIG. 13, a description is given of a process of outputting an answer to a question from a user, a related question, and the like to a display connected to the input/output unit 180.

In step S31, the dialogue unit 111 transmits a prompt including a question from the user to the language model server 200 to acquire an answer.

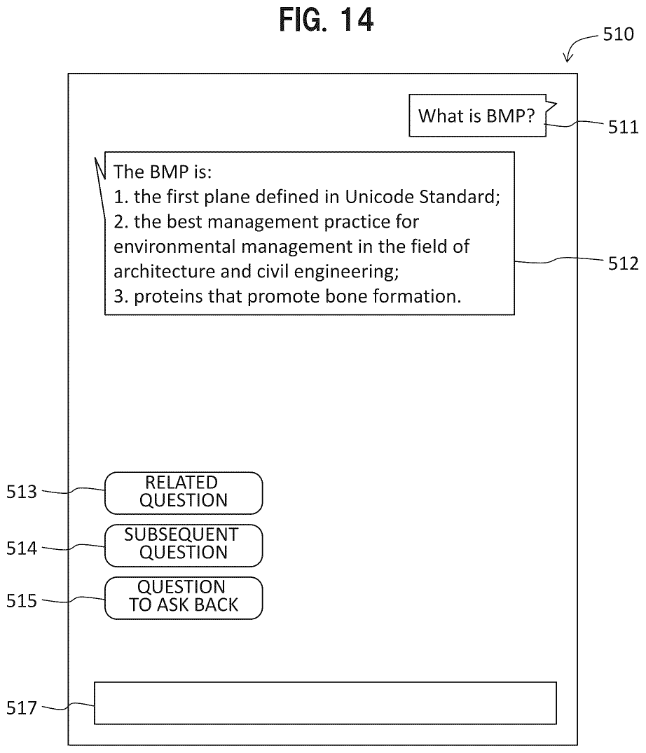

In step S32, the dialogue unit 111 outputs the question and the answer acquired in step S31. FIG. 14 is a diagram illustrating a dialogue screen 510 according to the embodiment. The message 511 is a question from the user. The message 512 is the answer acquired in step S31.

Referring to FIG. 13 again, the description of the dialogue process is continued.

Step S33 is the obvious information acquisition process described in FIG. 10. The obvious information acquisition process acquires obvious information related to the user's question (see the message 511 in FIG. 14).

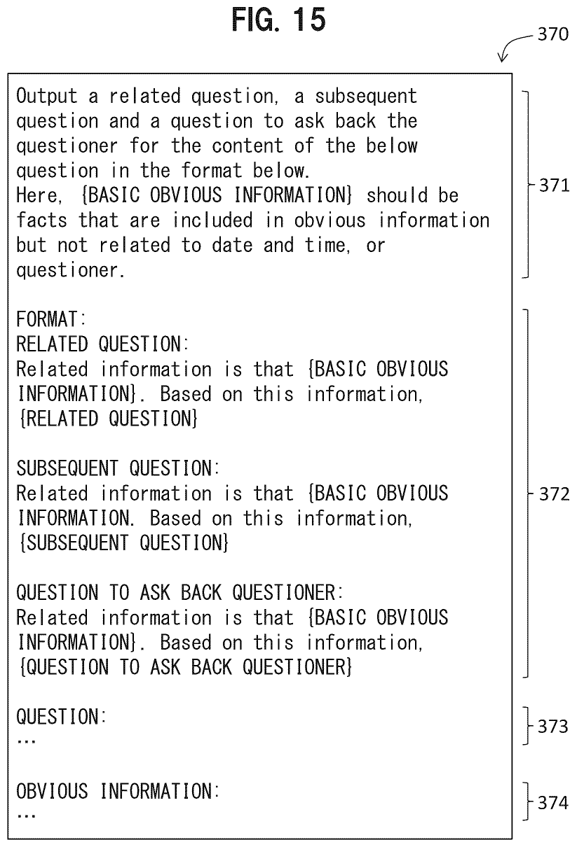

In step S34, the dialogue unit 111 generates a related question generation prompt 370 (see FIG. 15 described below). FIG. 15 is a diagram illustrating a related question generation prompt 370 according to the embodiment. The element 371 of the related question generation prompt 370 includes a sentence instructing output of a question related to the question in the element 373, a subsequent question, and a question to ask back to the questioner (user) in accordance with a format in the element 372 with reference to the obvious information in the element 374.

The element 373 includes a question (see the message 511). The elements 374 include the obvious information acquired in the step S33. The element 372 contains the format of the question to be output.

Referring to FIG. 13 again, the description of the dialogue process is continued.

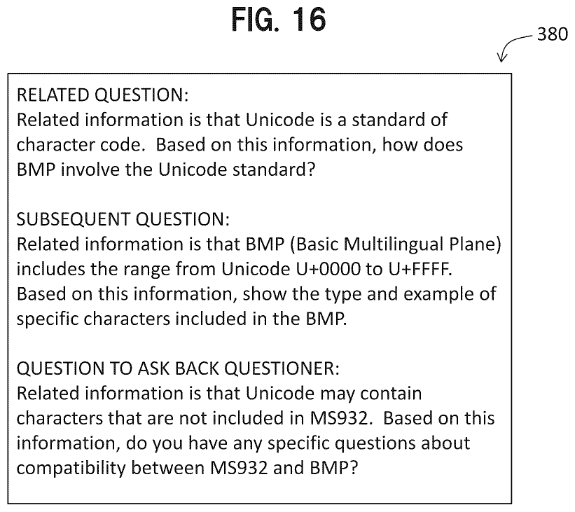

In step S35, the dialogue unit 111 transmits the associated question generation prompt 370 generated in step S34 to the language model server 200 to acquire an answer, and thereby acquires a related question. FIG. 16 is a diagram illustrating an answer 380 from the language model server 200 to the related question generation prompt 370 according to the embodiment. The answer 380 includes, as the related questions, a related question, a subsequent question, and a question to ask back to the questioner.

Referring to FIG. 13 again, the description of the dialogue process is continued.

In step S36, the dialogue unit 111 outputs a button for displaying the related question. A “related question” button 513 illustrated in FIG. 14 is a button that is output onto the dialogue screen 510 and displays a related question acquired in the step S35 on a text box 517 when the button is pressed. The “subsequent question” button 514 is a button that is output onto the dialogue screen 510 and that, when pressed, displays the subsequent question acquired in the step S35 on the text box 517. The “question to ask back” button 515 is a button that is output onto the dialogue screen 510 and that, when pressed, displays a question to ask back of the questioner acquired at the step S35 on the text box 517.

After the display of the above described buttons, when the user instructs a transmission of a question or a request for an answer, the dialogue process described with reference to FIG. 13 is executed for the displayed question, and buttons for displaying an answer and a related question are output in the same manner as the question indicated in the message 511. The user may directly input a question in the text box 517.

As described above, the dialogue device 100 includes the dialogue unit 111 that outputs the answer (see the answer 380 including the related question, and an answer 650) acquired by transmitting to the language model server 200 the prompt (see the related question generation prompt 370 illustrated in FIG. 15, and a question and answer generation prompt 640 illustrated in FIG. 21 described below) including the obvious information related to the tendency of the questioner who has asked the question.

The dialogue unit 111 includes the obvious information acquired by the premise knowledge extraction unit 114 into the prompt.

The prompt (see the related question generation prompt 370) is a prompt for requesting output of at least one of a question related to the question asked by the questioner, a question subsequent to the question asked by the questioner, and a question to ask back to the questioner.

### Features of Dialogue Device

The dialogue device 100 acquires a tendency of a user based on a question from a user, acquires obvious information related to the tendency, and outputs an associated question to the question from the user. The associated question (to the user's question) is, for example, a related question, a subsequent question, and a question to be asked back to the questioner, but may be another associated question.

The associated question is generated based on the technical terms understood by the user, problems/questions recognized by the user, technical terms required by the user, and the contents thereof, which are included in the tendency of the user. In other words, the question is generated based on the premise knowledge (tendency and obvious information). Therefore, the user is able to immediately ask a question for obtaining related information or information that the user wants to know further. The user can efficiently obtain the technical information.

### Modification: Premise Knowledge Database

In the above-described embodiment, the premise knowledge database 150 is constructed based on the dialogue log 140, but may be generated based on other information. For example, the database 150 may be generated based on in-house materials (in-organization material) such as specifications and user guides of equipment and a system, a business procedure manual, a written proposal, and a notice. The following shows the tendency and obvious information of a reader of the specification corresponding to the questioner in the dialogue using the specification of the system as an example.

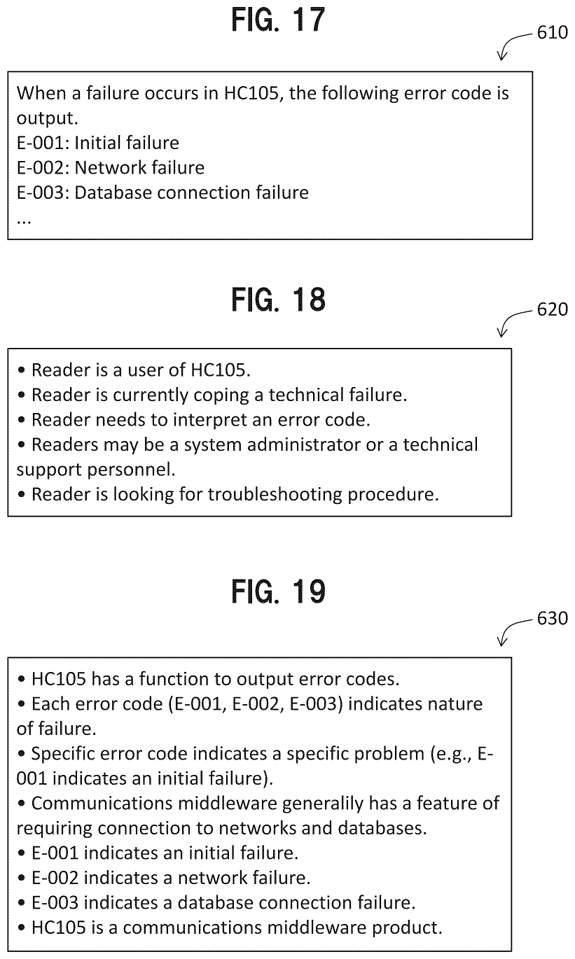

FIG. 17 is an example illustrating a part 610 of a specification according to a modification of the embodiment. In the above-described embodiment, the premise knowledge generation unit 113 generates the premise knowledge graph (see FIG. 8) for each dialogue of the dialogue log 140. The premise knowledge generation unit 113 in the modification may generate the premise knowledge graph, for example for each chapter or section of the specification

FIG. 18 is an example illustrating a tendency of readers of the specification according to the modification of the embodiment. FIG. 19 is an example illustrating obvious information of the specification according to the modification of the embodiment. The technical term database 130 for questions associated to the specification may use a glossary explaining terms extracted from the specification.

As described above, the tendency is the state of the readers of the in-organization material.

The obvious information is knowledge included in the in-organization material.

The premise knowledge generation unit 113 generates a premise knowledge generation prompt 330 for instructing extraction of a tendency and obvious information related to the tendency from the in-organization material, transmits the prompt 330 to the language model server 200 to acquire a tendency and obvious information related to the tendency and generates a premise knowledge database 150 including the acquired tendency and obvious information.

The premise knowledge extraction unit 114 acquires the similar tendency to the tendency of the questioner among the tendencies included in the premise knowledge database 150 and further acquires obvious information related to the tendency.

The dialogue unit 111 includes the obvious information acquired by the premise knowledge extraction unit 114 into the prompt.

The premise knowledge generation unit 113 generates one or more premise knowledge databases 150 according to an affiliation or role of the reader.

The premise knowledge extraction unit 114 selects the premise knowledge database 150 according to the affiliation or role of the questioner to acquire the obvious information.

### Modification: Direct Answer to Question

In the above-described embodiment, the dialogue device 100 generates, as questions associated to a question from a user, a related question, a subsequent question, and a question to be asked back to the questioner. The dialogue device 100 may answer a question from the user.

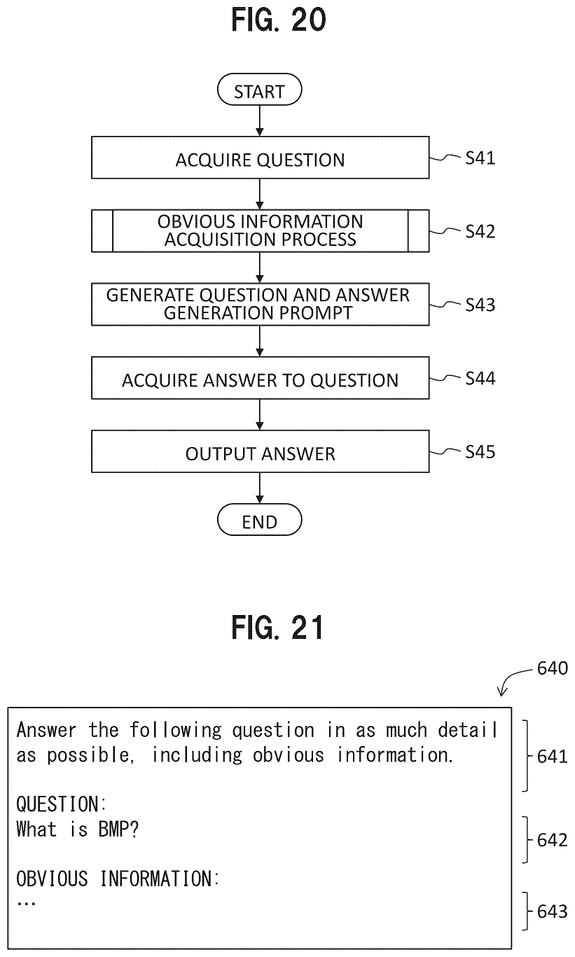

FIG. 20 is a flowchart of the dialogue processing according to the modification of the embodiment. Referring to FIG. 20, a description is given of a process of outputting an answer to a question from a user onto a display connected to the input/output unit 180.

In step S41, the dialogue unit 111 acquires a question from a user. In the following, the question is assumed to be “What is a BMP?” (see a message 511 in FIG. 14).

Step S42 illustrates the obvious information acquisition process described in FIG. 10. The obvious information related to the question from the user is acquired by the obvious information acquisition process.

In step S43, the dialogue unit 111 generates a question and answer generation prompt 640 (see FIG. 21 described below). FIG. 21 is a diagram illustrating a question and answer generation prompt 640 according to the modification of the embodiment. An element 641 of the question and answer generation prompt 640 includes a sentence instructing to output an answer to the question in an element 642 by referring to the obvious information in an element 643. The element 642 includes the questions obtained in the step S41. Elements 643 include the obvious information obtained in step S42.

Referring back to FIG. 20, the description of the dialogue process is continued.

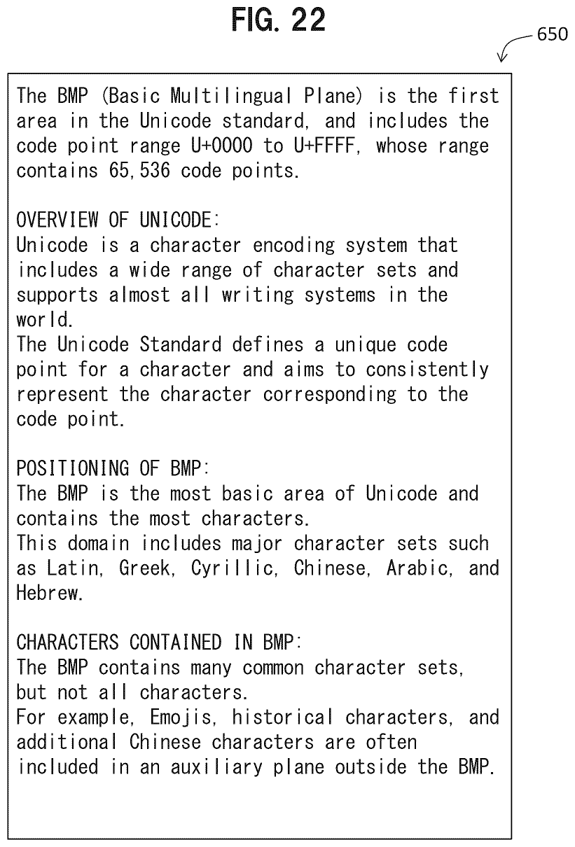

In step S44, the dialogue unit 111 transmits the question and answer generation prompt 640 generated in the step S43 to the language model server 200 to acquire an answer. FIG. 22 is a diagram illustrating an answer 650 from the language model server 200 to the question and answer generation prompt 640 according to the modification of the embodiment.

Referring back to FIG. 20, the description of the dialogue process is continued.

In step S45, the dialogue unit 111 outputs the answer 650.

The dialogue device 100 according to such a modification acquires the answer to the user's question itself by including the obvious information related to the user's tendency into the prompt and displays the answer. The answer from the language model server 200 to the question “What is the BMP?” includes an answer of specialized fields different from the BMP that the user thinks as indicated by a message 512 described in FIG. 14. The dialogue device 100 is able to output an answer in accordance with the recognition of the user by acquiring the tendency of the questioner and using the prompt including the obvious information related to the tendency (see the question and answer generation prompt 640),. Therefore, the user can efficiently resolve the question or the unclear point.

As described above, the prompt (see the question and answer generation prompt 640) is a prompt for requesting an answer to the question 640 (see the message 511 illustrated in FIG. 14) asked by the questioner.

### Modification: Inquiry about Applicability of Premise Knowledge

The dialogue screen 510 (see FIG. 14) displays a text box 517. The user can ask a question following the message 511 by inputting the question in the text box 517. An answer to the question may be output through the dialogue process illustrated in FIG. 20. More specifically, the dialogue device 100 outputs the answer 650 (see FIG. 22) based on the premise knowledge (obvious information), not based on a related question or a subsequent question.

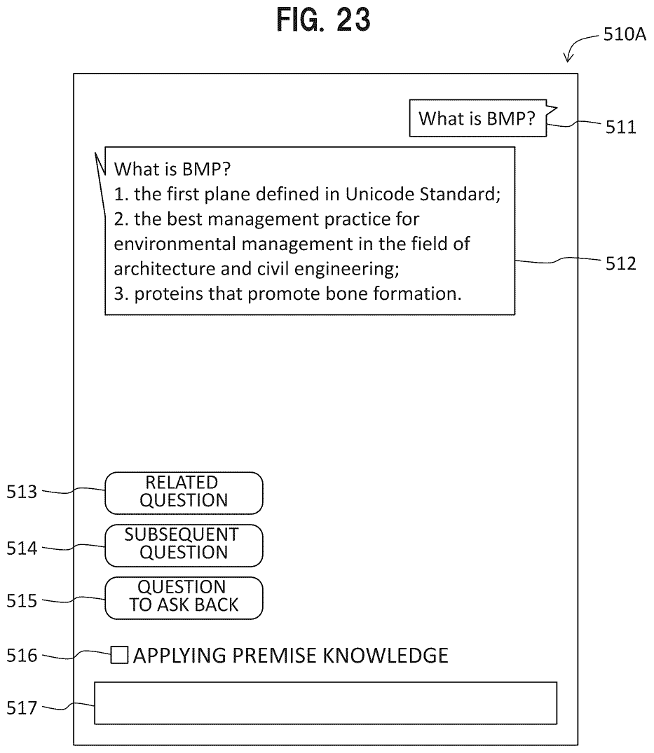

FIG. 23 is a diagram illustrating a dialogue screen 510A according to the modification of the embodiment. When a check box 516 located above the text box 517 is checked, the dialogue unit 111 outputs an answer based on the premise knowledge. If the button is not checked, the dialogue unit 111 executes the dialogue process shown in FIG. 13 to acquire the related question, the subsequent question, and the like, and outputs the buttons for displaying such questions.

As described above, when assuming the obvious information is selected for the answer to the question asked by the questioner (the checkbox 516 is checked), the dialogue unit 111 outputs the answer acquired by transmitting the prompt (see the question and answer generation prompt 640) for requesting the answer to the question made by the questioner to the language model server 200.

When assuming the obvious information is not selected for the answer to the question asked by the questioner, the dialogue unit 111 outputs the answer acquired by transmitting, to the language model server 200, the prompt (see the related question generation prompt 370) for requesting output of at least one of a question related to the question asked by the questioner, a question following the question asked by the questioner, and a question to ask back to the questioner.

### Other Modifications

Although some embodiments of the present invention are described above, these embodiments are merely exemplifications and do not limit the technical scope of the present invention. The present invention can be embodied in other various forms, and various changes such as omission and replacement can be made without departing from the spirit of the present invention. These embodiments and their modifications are included in the scope and spirit of the invention described in the present specification and the like and included in the invention described in the claims and the scope of equivalents thereof.

### Hardware Configuration

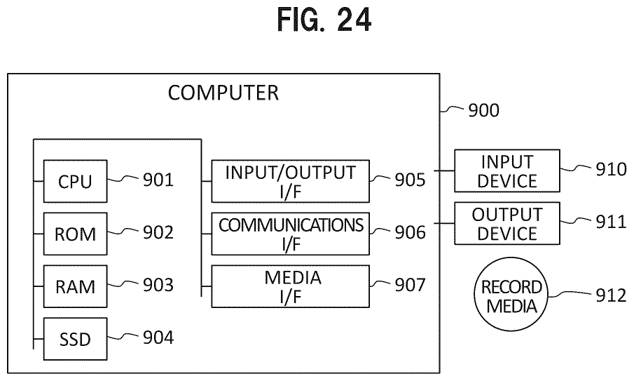

The dialogue device 100 according to the above-described embodiment may be implemented by a computer 900 having a configuration as illustrated, for example in FIG. 24. FIG. 24 is a hardware configuration diagram illustrating an example of a computer 900 that implements the functions of the dialogue device 100 according to the above-described embodiment. The computer 900 includes a CPU 901, a ROM 902, a RAM 903, an SSD 904, and an input/output interface 905 (described as an input/output interface (I/F) in FIG. 24). The computer 900 further includes a communication interface 906 (described as a communication I/F in FIG. 24) and a media interface 907 (described as a media I/F in FIG. 24). The computer 900 may include a hard disc drive (HDD) instead of the SSD 904, or may further include the HDD in addition to the SSD 904.

The CPU901 operates based on a program stored in the ROM 902 or the SSD 904, and performs control executed by the control unit 110 in FIG. 1. The ROM 902 stores a boot program executed by the CPU901 at a time of activation of the computer 900, a hardware related program of the computer 900, and the like.

The CPU901 controls input devices 910 such as a mouse and a keyboard and output devices 911 such as a display and a printer via the input/output interface 905. The CPU901 acquires data from the input device 910 and outputs generated data to the output device 911 via the input/output interface 905.

The SSD 904 stores a program executed by the CPU 901 and data used by the program. The communication interface 906 receives data from another device (not shown), for example, the language model server 200 via a communications network and outputs the data to the CPU 901, and transmits information generated by the CPU 901 to another device via the communications network.

The media interface 907 reads programs or data stored in the recording media 912 and outputs them to the CPU 901 via the RAM 903. The CPU 901 loads the program from the recording media 912 onto the RAM 903 via the media interface 907, and executes the loaded program. The recording medium 912 is an optical recording medium such as a Digital Versatile Disk (DVD) , a magneto optical recording medium such as a Magneto Optical disk (an MO), a magnetic recording medium, a conductor memory tape medium, a semiconductor memory, or the like.

For example, when the computer 900 functions as the dialogue device 100 according to the above-described embodiment, the CPU 901 of the computer 900 executes the program 128 (see FIG. 1) loaded on the RAM 903 to implement the function of the dialogue device 100. The CPU 901 reads and executes the program from the recording media 912. In addition, the CPU 901 may read the program from another device via the communications network, or may install the program 128 from the recording media 912 into the SSD 904 and execute the program.

### Reference Signs List

100: dialogue device
111: dialogue unit
112: vectorization unit
113: premise knowledge generation unit
114: premise knowledge extraction unit
121: vectorization model
130: technical term database
140: dialogue log
150: premise knowledge database
200: language model server
310: technical term explanation prompt
330: premise knowledge generation prompt
350: tendency generation prompt
370: related question generation prompt
410: premise knowledge graph
640: question and answer generation prompt

1. A dialogue device comprising a processor and memory,
the processor configured to execute functions of:
a dialogue unit that outputs an answer acquired by transmitting to a language model server a prompt including related obvious information that is related to a tendency of a questioner who has asked a question, wherein
the tendency is language information associated with the question and associated with a state of the questioner, and wherein
the obvious information is language information representing knowledge associated with the question.

2. The dialogue device according to claim 1, wherein
the processor is further configured to execute functions of:
a premise knowledge generation unit that:
generates a premise knowledge generation prompt for instructing extraction of the tendency and the related obvious information to the tendency from a dialogue log including a question asked by a second questioner including one or both of the questioner and a different questioner from the questioner and an answer to the question from the language model server; and
generates a premise knowledge database including the tendency and the related obvious information to the tendency acquired by transmitting the premise knowledge generation prompt to the language model server, and
a premise knowledge extraction unit that acquires a similar tendency that is similar to the tendency of the questioner from among tendencies included in the premise knowledge database and acquires the related obvious information to the tendency, wherein
the dialogue unit includes into the prompt the obvious information acquired by the premise knowledge extraction unit.

3. The dialogue device according to claim 2, wherein
the premise knowledge generation unit generates one or more premise knowledge databases according to an affiliation or a role of the second questioner; and
the premise knowledge extraction unit selects the premise knowledge database according to the affiliation or the role of the questioner to acquire the obvious information.

4. The dialogue device according to claim 2, wherein
the premise knowledge generation unit includes an explanatory text of a technical term included in the question from the second questioner into the premise knowledge generation prompt.

5. The dialogue device according to claim 1, wherein
the tendency includes a state of a reader of an in-organization material;
the obvious information includes knowledge included in the in-organization material, and
the processor executes functions of:
a premise knowledge generation unit that:
generates a premise knowledge generation prompt for instructing extraction of the tendency and the related obvious information to the tendency from a dialogue log including a question asked by a second questioner including one or both of the questioner and a different questioner from the questioner and an answer to the question from the language model server; and
generates a premise knowledge database including the tendency and the related obvious information to the tendency acquired by transmitting the premise knowledge generation prompt to the language model server, and
a premise knowledge extraction unit that acquires a similar tendency that is similar to the tendency of the questioner from among tendencies included in the premise knowledge database and acquires related obvious information to the tendency, wherein
the dialogue unit includes the obvious information acquired by the premise knowledge extraction unit into the prompt.

6. The dialogue device according to claim 5, wherein
the premise knowledge generation unit generates one or more of the premise knowledge databases according to an affiliation or a role of the reader; and
the premise knowledge extraction unit selects the premise knowledge database according to the affiliation or the role of the questioner to acquire the obvious information.

7. The dialogue device according to claim 2, wherein
the premise knowledge extraction unit acquires similar obvious information to the obvious information in addition to the related obvious information to the tendency.

8. The dialogue device according to claim 1, wherein
the prompt is a prompt requesting an output of any one or more of:
a question related to the question asked by the questioner;
a subsequent question to the question asked by the questioner; and
a question to ask back of the questioner.

9. The dialogue device according to claim 1, wherein
the prompt includes:
a prompt requesting an answer to the question asked by the questioner.

10.
The dialogue device according to claim 1, wherein
the dialogue unit:
outputs an answer acquired by transmitting to the language model server a prompt for requesting an answer to the question asked by the questioner,
when the obvious information is selected as a presupposition for the question asked by the questioner; and
outputs an answer acquired by transmitting to the language model server a prompt for requesting an output of any one or more of:
a related question to the question asked by the questioner;
a subsequent question following the question asked by the questioner; and
a question to ask back of the questioner,
when the obvious information is not selected as a presupposition for the question asked by the questioner.

11. A dialogue method executed by a dialogue device including a processor and memory,
the processor of the dialogue device executing:
outputting an answer acquired by transmitting to a language model server a prompt including related obvious information to a tendency of a questioner who has asked a question, wherein
the tendency includes language information associated to the question and associated to a state of the questioner; and
the obvious information includes language information describing knowledge associated to the question.

12. The dialogue device according to claim 5, wherein
the premise knowledge extraction unit acquires similar obvious information to the obvious information in addition to the related obvious information to the tendency.
